(19) United States
(12) Patent Application Publication
(10) Pub. No.: US 2007/0192379 A1
(43) Pub. Date: Aug. 16, 2007

(54) Method of analyzing information flow within an organization

(76) Inventors: William Derek Finley, Ottawa (CA); Christopher William Doylend, Ottawa (CA); Gordon Freedman, Nepean (CA)

Correspondence Address: FREEDMAN & ASSOCIATES, 117 CENTREPOINTE DRIVE, SUITE 350, NEPEAN, ONTARIO, K2G 5X3, omitted

(21) Appl. No.: 11/698,970

(22) Filed: Jan. 29, 2007

Related U.S. Application Data
(60) Provisional application No. 60/762,514, filed on Jan. 27, 2006.

(51) Int. Cl. G06F 17/30

(52) U.S. Cl. 707/200

(57) ABSTRACT

A method of analyzing information flow within an organization includes defining a three-dimensional data visualization structure of the organization including interconnections between organizational elements of the organization. Data flow is processed based on a set of known rules relating to information flow via the interconnections and based upon a flow structure through the organization, so as to simulate moving in time through organizational data upon the set of known rules, from a first endpoint data in order to generate a second endpoint data. In particular, the second endpoint data is one of forward and backward in time relative to the first endpoint data. The second endpoint data is verified against a predetermined outcome and an indication of the result of verifying is provided.

This application claims the benefit of U.S. Provisional Application No. 60/762,514, filed on Jan. 27, 2006, the entire contents of which are incorporated herein by reference.

### FIELD OF THE INVENTION

The present invention relates generally to the storage and display of correlated data, and more particularly to a method of analyzing the flow of information within an organization.

### BACKGROUND

Data storage, analysis, retrieval and display have always been important aspects of computers. Although different data retrieval and data display models have been proposed over the years, most system designers return to one of three models due to their simplicity, ease of use, and user comprehensibility. These three models include the desktop model, the list based model, and the hierarchical list model.

The desktop model was popularized by Apple® with its Macintosh® computers, and is used to display computer operating system data in a virtual desktop environment. On a computer screen is shown an image of a two-dimensional desktop with files, folders, a trashcan, and so forth being represented by different icons that are arranged in some manner on the “surface” of the desktop. To access files that are stored on the computer system, a user simply selects an appropriate icon from the desktop display. Though the desktop model is convenient and intuitive, it is often difficult to implement due to system level constraints. For example, the Windows® operating system that is provided by Microsoft® Corporation has limitations on file name length and, as such, is sometimes unable to store files sufficiently deeply within nested folders to truly reflect the desktop based model. Further, since some systems are more limited than others, the model when implemented results in some limitations on portability. For many applications and for application execution, the desktop model is often poor.

Also, though the desktop model is well suited to providing user references for many different functions, it is poorly suited for organizing large volumes of data since it has no inherent organizational structure other than the one that is set by a user. Thus, similar to actual physical desktops, some virtual desktops are neat and organized while others are messy and disorganized. Thus, for data organization and retrieval, the virtual desktop model is often neutral—neither enhancing nor diminishing a user's organizational skills.

The list-based model is employed in all aspects of daily life. For instance, music organization programs display music identifiers such as titles and artists in a list that is sortable and searchable based on many different criteria. Typically, sort criteria are displayed as column headers allowing for easy searching based on the column headers. Many applications support more varied search criteria and search definition.

Another example of list based data display is Internet search engines, which typically show a list of results for a provided search query. The results are then selectable for navigating to a World Wide Web Site relating to the listed result. Unfortunately, with the wide adoption of the World Wide Web and with significant attempts to get around search engine technology—to “fool” the search engines—it is often difficult to significantly reduce a search space given a particular query. For example, the search term “fingerprint” returns a significant number of results for biometric based fingerprinting similar to that used by police and a significant number of results for genetic fingerprinting using DNA. These results are distinct one from another.

The hierarchical list is similar to the list-based model but for each element within a higher-level list, there exist further sub-items at a lower level. Thus, a first set of folders allows for selection of a folder having within it a set of subfolders, etc. This allows for effective organization of listed data. In the above noted music list program example, classical music can be stored in a separate sub list from country music, etc.

Some complex data structures, such as for instance the organizational charts of large corporations, or of other similarly organized bodies such as for instance government or military units, consist of interconnected and highly correlated nodes. For instance, hierarchal organization charts of a large corporation include typically a separate chart for each different unit of the corporation, with individuals and/or departments in each unit being represented as separate nodes in the chart, and with relationships between the separate nodes in the chart being shown as interconnections in two-dimensions. That said, it is often the case that relationships exist between individuals and/or departments in different units of the corporation, and accordingly the nodes of one chart actually are interconnected with the nodes of one or more of the other charts. Furthermore, it is often the case that different types of relationships exist between the nodes, such as for instance reporting relationships, communication relationships, financial relationships, etc. Unfortunately, current methods for analyzing and visualizing such highly correlated sets of data do not produce results that are intuitive to the user, and as a result the analysis is cumbersome and prone to errors and the visualization is confusing and prone to omissions. This leads to a situation in which it is difficult to audit the flow of information within a large organization. Often those who must sign off as being responsible for ensuring that rules, regulations and procedures are followed within the organization actually cannot be certain that such is actually the case. When criminal activity, negligence or other tomfoolery has occurred, even unbeknownst to the responsible person, it is nevertheless to that person that any associated liability accrues.

It would be advantageous to provide a method for analyzing and/or visualizing highly correlated data sets that overcomes at least some of the above-mentioned limitations of the prior art.

### SUMMARY OF EMBODIMENTS OF THE INSTANT INVENTION

According to an aspect of the instant invention there is provided a method of analyzing information flow within an organization, comprising: defining interconnections between data nodes belonging to an organizational chart of the organization and network nodes belonging to a computer and information technology network chart of the organization, the defined interconnections for correlating the organizational chart and the computer and information technology network chart in three-dimensions so as to provide a three-dimensional data visualization structure of the organization; establishing rules relating to information flow via the interconnections, the rules based upon a flow structure through the organization; processing data flow through the organization to move in time from a first data point to a second data point in accordance with the established rules; and, providing an indication of the result of the processing step.

According to an aspect of the instant invention there is provided a method of analyzing information flow within an organization, comprising: defining a three-dimensional data visualization structure of the organization including interconnections between organizational elements of the organization; processing data flow based on a set of known rules relating to information flow via the interconnections and based upon a flow structure through the organization, so as to simulate moving in time through organizational data upon the set of known rules, from a first endpoint data in order to generate a second endpoint data, the second endpoint data one of forward and backward in time relative to the first endpoint data; verifying the second endpoint data against a predetermined outcome; and, providing an indication of the result of verifying.

According to an aspect of the instant invention there is provided a method of analyzing information flow within an organization, comprising: defining interconnections between data nodes belonging to a first organizational chart of the organization and data nodes belonging to a second organizational chart of the organization, the defined interconnections for correlating the first organizational chart and the second organizational chart in three-dimensions so as to provide a three-dimensional data visualization structure of the organization; correlating a three-dimensional visualization of a computer and information technology network of the organization with the three-dimensional data visualization structure of the organization, comprising defining other interconnections relating to node access to the computer and information technology network of the organization; establishing rules relating to the interconnections and to the other interconnections, the rules based upon a predetermined reporting process; verifying a set of reporting process values against the three-dimensional data visualization structure of the organization following the rules established for the interconnections and for the other interconnections; and, providing an indication of the result of verifying.

According to an aspect of the instant invention there is provided a computer-readable storage medium having stored thereon computer-executable instructions for performing a method of analyzing information flow within an organization, the method comprising: defining a three-dimensional data visualization structure of the organization including interconnections between organizational elements of the organization; processing data flow based on a set of known rules relating to information flow via the interconnections and based upon a flow structure through the organization, so as to simulate moving in time through organizational data upon the set of known rules, from a first endpoint data in order to generate a second endpoint data, the second endpoint data one of forward and backward in time relative to the first endpoint data; verifying the second endpoint data against a predetermined outcome; and, providing an indication of the result of verifying.

### BRIEF DESCRIPTION OF THE DRAWINGS

Exemplary embodiments of the invention will now be described in conjunction with the following drawings, in which similar reference numerals designate similar items:

FIG. 1 shows a simplified diagram of a three-dimensional data visualization structure in accordance with an embodiment of the instant invention;

FIG. 2 shows the three-dimensional data visualization structure of FIG. 1 after rotation;

FIG. 3a is a simplified schematic of an embodiment of the invention wherein the organization chart of an organization is displayed with overlays for management reporting as well as project reporting;

FIG. 3b shows a slice diagram relating to the organization;

FIG. 4 is a simplified schematic of an embodiment of the invention wherein the Information Technology resources of an organization chart are mapped;

FIG. 5 is a simplified flow diagram for a method of analyzing information flow within an organization according to an embodiment of the instant invention;

FIG. 6 is a simplified flow diagram for a method of analyzing information flow within an organization according to another embodiment of the instant invention; and,

FIG. 7 is a simplified flow diagram for a method of analyzing information flow within an organization according to another embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and the scope of the invention. Thus, the present invention is not intended to be limited to the embodiments disclosed, but is to be accorded the widest scope consistent with the principles and features disclosed herein.

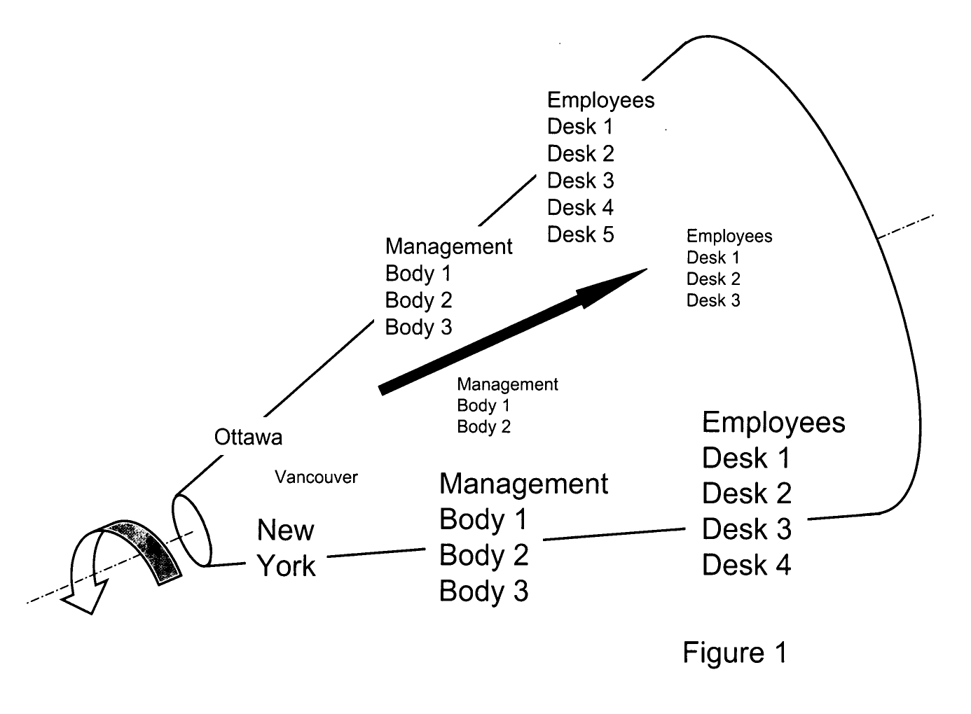

Referring to FIG. 1, shown is a three dimensional listing of organizational chart data relating to a corporation, or to another similarly organized body such as for instance a government department, a military unit, an aid agency, an educational institution, a retail chain, a transportation system, a volunteer association, a parts list, a software program, a patent, a supply and services contract, a computer network, etc. Any such organized body is referred to hereinafter simply as “the organization,” and the organizational charts associated therewith are referred to simply as “org charts.” In FIG. 1 the data is shown distributed on a surface of a three-dimensional cone for simplicity of discussion, though of course any of a number of other three-dimensional representations optionally is supported. For instance, optionally the three dimensional structure of the data being presented is spherical, a surface of a sphere, cubic, a surface of a cube, or is placed in accordance with another algorithm, manually, or randomly within a three dimensional or hierarchical three-dimensional space.

The org chart data that is shown in FIG. 1 represents a reporting org chart for the organization, or optionally for a portion thereof. In the instant example the data is sorted by office location (New York, Ottawa and Vancouver) around the cone and by hierarchal order within each office along a linear axis of the cone. Further, the New York office location is shown at the front of the cone (nearest the user) and the Vancouver office location is shown at the back of the cone (away from the user) with the Ottawa office location being shown at a position intermediate the New York and Vancouver office locations. As will be apparent, the size of the text font in FIG. 1 serves the purpose of providing a three-dimensional perspective, with text that is positioned closest to the user being the largest and text that is farthest away from the user being the smallest. Numerous other methods of achieving a 3D visualization structure and of placing information within a display area are envisaged for use with the invention.

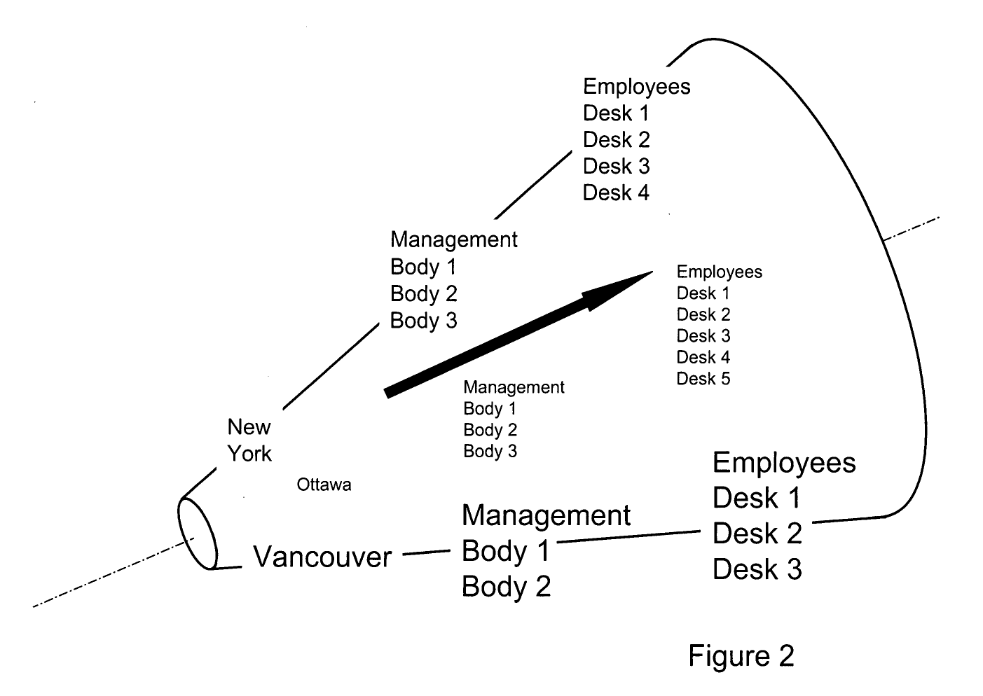

Due to the size of the organization, it is advantageous to utilize a three-dimensional data representation model in order to support convenient visualization of interconnections for reporting purposes, etc. Advantageously, the org chart so presented allows for moving of individuals within the organization. Furthermore, the org chart data is easily manipulated—rotated or traversed—to identify correlated data according to a user perspective. So for example, rotation of the cone in the direction that is shown in FIG. 1 brings the Vancouver office location forward as is shown in FIG. 2. The user optionally “drills in” or “drills out” to display other data that is correlated with any of the data shown in FIG. 2. Of course, with a three-dimensional cone based structure, viewing the structure from above or below is one or more circles and, as such, allows for a view of the organization at a glance. Preferably, a process for coupling and decoupling of elements within the three dimensional view is provided for grouping of elements or for entering correlative data relating to different elements. Further preferably, viewing processes include navigation tools for rotating, translating, and navigating the three-dimensional view space.

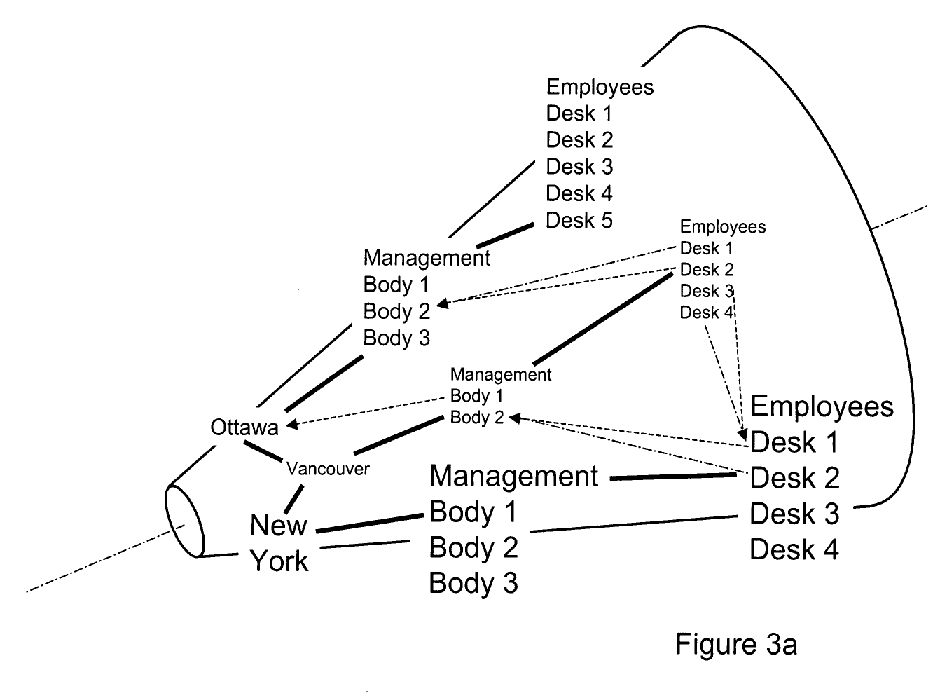

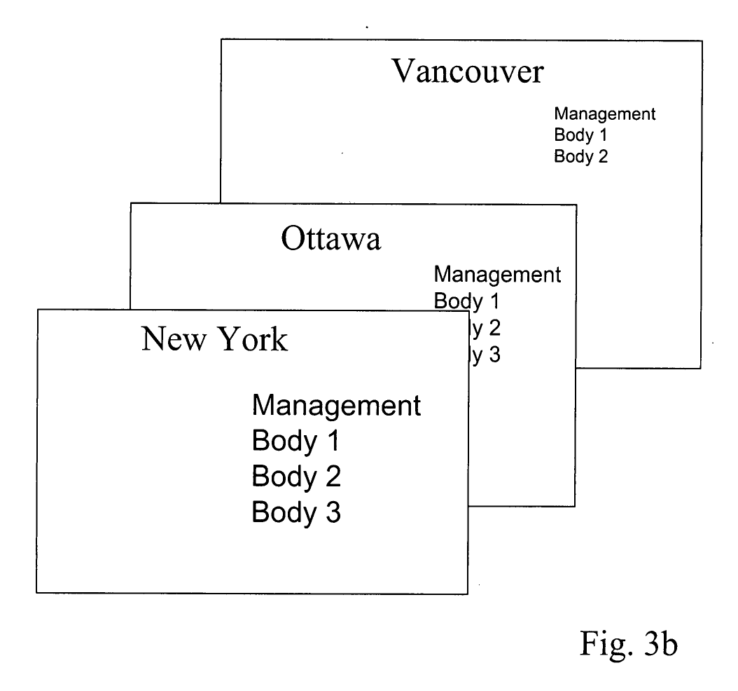

Referring to FIG. 3a, shown is another three-dimensional listing of org chart data, highlighting a plurality of different interconnections including those of a communication org chart represented by dashed lines, those of a reporting org chart represented by solid lines and those of a project org chart represented by dotted lines. Here, reporting is performed on a functional basis, projects on a product basis, and communication via the legal, human resources, and communications departments. The different interconnects are shown between different slices of the organization, as is shown in FIG. 3b. Each slice is presented as a reporting org chart with the other org charts represented as interconnects between slices. By moving the slices, interconnections are both visible and more easily comprehended. Advantageously, a plurality of overlaid org charts provides many advantages. Firstly, corporate reorganizations are more easily viewed since, most often, they affect only reporting while retaining all other aspects of an organization. Secondly, managing information flow within an organization is facilitated since its flow for each distinct purpose is now mappable. Thirdly, by attributing rules to the interconnections, simulation of events and actual analysis of real events—in other words business information analysis—becomes a real possibility as is discussed in greater detail, below. Some examples of rules include policies, behavioural descriptions, functional descriptions, guidelines, and so forth.

In each of the above examples interconnections are defined for correlating different org charts in three-dimensions, so as to provide a three-dimensional data visualization structure of the organization. Advantageously, the user has the ability to also define rules within the three-dimensional structure, such that data can traverse the three-dimensional structure in accordance with those rules. Rules are optionally applied to govern a ‘shape’ of the structure itself as well as its visualization—for example wysiwyg applied to all four elements—structure, data, behaviour, and communications—resulting in an intelligent model of the organization that is potentially useful not only to understand it, but to use it more effectively and to improve its performance through visualization. Thereafter, when data is mapped onto the three-dimensional structure the rules are applied such that the data “flows” through the organization. Further, when the user is provided an opportunity to move blocks within the three-dimensional viewing space, it is possible to isolate blocks or groups of blocks while maintaining the rest of the organization. For example, a slice view of an organization of the information flow therethrough is provided. By moving some blocks, an additional slice is created for analysis, blocks within the slice relating to something being analyzed.

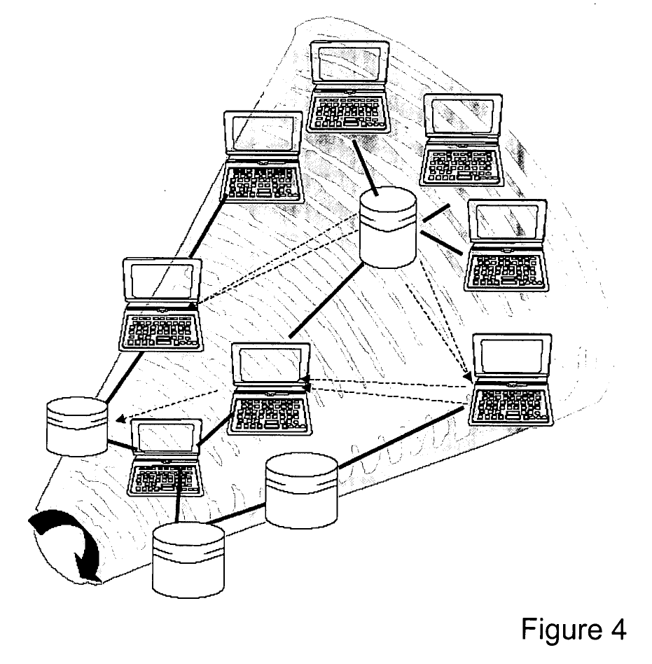

Referring to FIG. 4, a simplified three-dimensional diagram of a computer and information technology network is shown. Here, rules within the diagram exist for each interconnection, such as for instance relating to auditing and tracking of data flow. Thus, messages entering the organization are tracked and audited in accordance with a set of rules associated with the diagram. The use of such a visualization and analysis tool allows for monitoring of email archiving, data bottlenecks, information hoarding events, ineffective or inefficient network utilization and much more. For example, a single email message is optionally simulated or displayed as audited for review. The use of the visualization tool improves overall understanding of data flow and assists in locating and isolating of problems within an information technology infrastructure.

One useful application, which is provided hereinbelow as a non-limiting example, relates to analyzing and tracking the flow of information within an organization. Advantageously, by merging the organization charts of FIGS. 3 and 4, it is possible to analyze information flow within an organizational structure. This is useful, for example, in ensuring that securities exchange regulations and government regulations, such as recently enacted legislation affecting executives, directors, and board members, referred to as the Sarbanes-Oxley Act of 2002 (Pub. L. No. 107-204, 116 Stat. 745), are followed. One of the major provisions of this act is a requirement that public companies evaluate and disclose the effectiveness of their internal controls as they relate to financial reporting, and that independent auditors for such companies “attest” (i.e., agree, or qualify) to such disclosure. Other provisions include a requirement for the certification of financial reports by chief executive officers and chief financial officers as well as enhanced criminal and civil penalties for violations of securities law.

The Sarbanes-Oxley Act also resulted in the creation of the Public Company Accounting Oversight Board (PCAOB). Auditing Standard No. 2′ of the Public Company Accounting Oversight Board (PCAOB) has the following key requirements:
The design of controls-relevant assertions related to all significant accounts and disclosures in the financial statements
Information about how significant transactions are initiated, authorized, supported, processed, and reported
Enough information about the flow of transactions to identify where material misstatements due to error or fraud could occur
Controls designed to prevent or detect fraud, including who performs the controls and the regulated segregation of duties
Controls over the period-end financial reporting process
Controls over safeguarding of assets
The results of management's testing and evaluation

Clearly, in order to satisfy the above-mentioned requirements relating to this single Act it is necessary to analyze different types of interconnections and relationships within an organization with a global perspective. Automation of many of these tasks is possible according to at least one embodiment of the instant invention. For instance, correlating org chart data into a three dimensional data structure as discussed supra and assigning rules to the interconnections between data nodes in the org charts allows the flow of data to be tracked through the entire organization in accordance with those rules. Furthermore, depending upon the type of analysis that is required, different rules are applied to the same interconnections at different times. As such, an official reporting process is verifiable against the org chart following the rules associated with interconnections, to ensure that the requirements are met and to ensure that liability is not accruing to management.

In addition to the type of analysis that is described above, it is also possible to assign rules to the interconnections within the three-dimensional data structure for simulating events either forward or backward in time. In general, a simulation that progresses backwards in time from a first data point to a second data point in accordance with the established rules is useful for determining the cause of a known problem. Alternatively, a simulation that progresses forwards in time from a first data point to a second data point in accordance with the established rules is useful for determining a likely outcome of a decision, change to the organizational structure, etc.

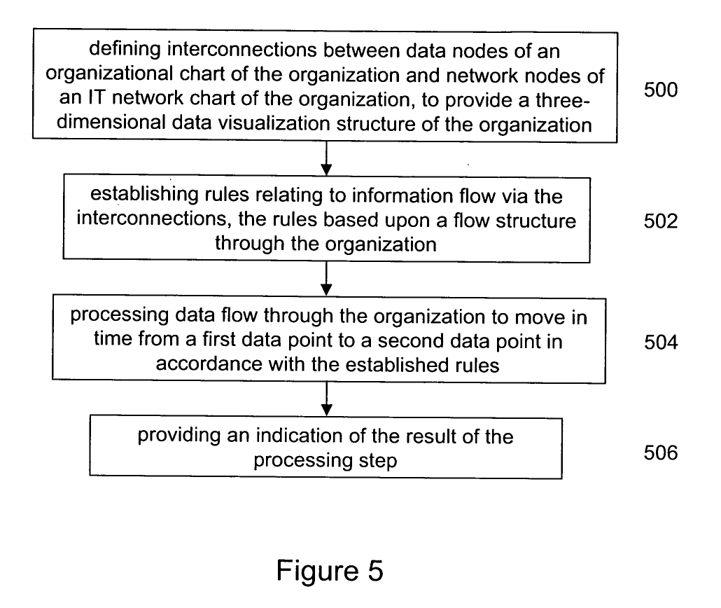

Referring now to FIG. 5, shown is a simplified flow diagram for a method of analyzing information flow within an organization according to an embodiment of the instant invention. At step 500 interconnections are defined between data nodes belonging to an organizational chart of the organization and network nodes belonging to a computer and information technology network chart of the organization. The defined interconnections are for correlating the organizational chart and the computer and information technology network chart in three-dimensions so as to provide a three-dimensional data visualization structure of the organization. At step 502, rules are established relating to information flow via the interconnections, the rules based upon a flow structure through the organization. At step 504 data flow is processed through the organization to move in time from a first data point to a second data point in accordance with the established rules. At step 506 an indication of the result of the processing step is provided.

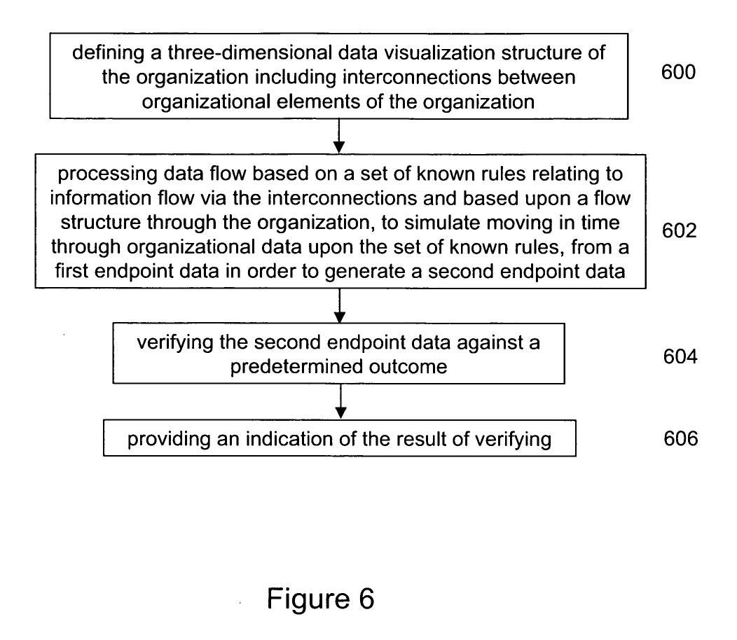

Referring now to FIG. 6, shown is a simplified flow diagram for a method of analyzing information flow within an organization according to another embodiment of the instant invention. At step 600 a three-dimensional data visualization structure of the organization is defined, including interconnections between organizational elements of the organization. At step 602 data flow is processed based on a set of known rules relating to information flow via the interconnections, and based upon a flow structure through the organization, so as to simulate moving in time through organizational data upon the set of known rules, from a first endpoint data in order to generate a second endpoint data. In particular, the second endpoint data is one of forward and backward in time relative to the first endpoint data. At step 604 the second endpoint data is verified against a predetermined outcome. At step 606 an indication of the result of the verifying step is provided.

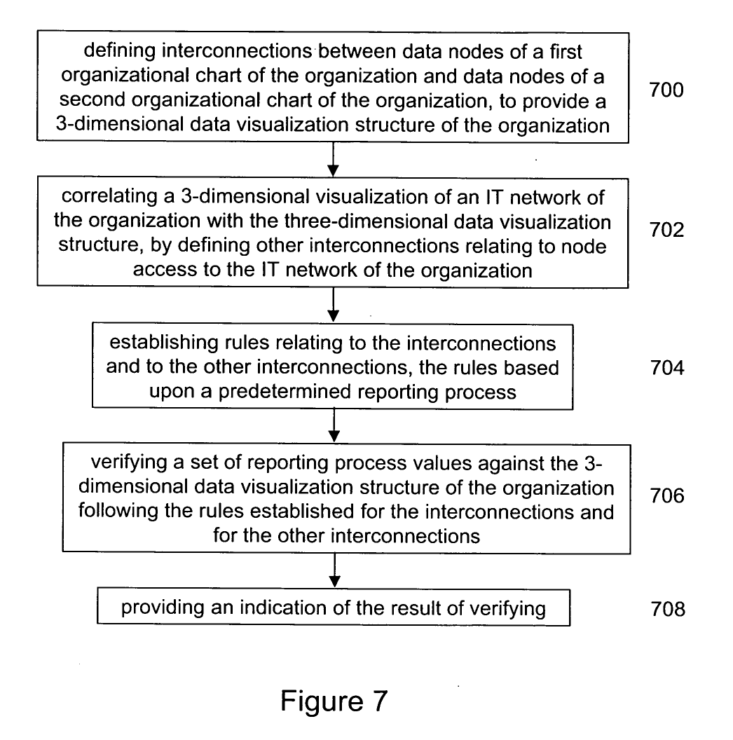

Referring now to FIG. 7, shown is a simplified flow diagram for a method of analyzing information flow within an organization according to another embodiment of the instant invention. At step 700 interconnections are defined between data nodes belonging to a first organizational chart of the organization and data nodes belonging to a second organizational chart of the organization. The defined interconnections are for correlating the first organizational chart and the second organizational chart in three-dimensions, so as to provide a three-dimensional data visualization structure of the organization. At step 702 a three-dimensional visualization of a computer and information technology network of the organization is correlated with the three-dimensional data visualization structure of the organization, comprising defining other interconnections relating to node access to the computer and information technology network of the organization. At step 704 rules are established relating to the interconnections and to the other interconnections, the rules based upon a predetermined (see below) reporting process. At step 706 a set of reporting process values is verified against the three-dimensional data visualization structure of the organization following the rules established for the interconnections and for the other interconnections. At step 708 an indication of the result of the step of verifying is provided

Optionally, processing of information flow through an organization is performed in time steps. At each time step, a series of rules are applied to different data nodes. A set of output values results from application of the rules and is then used as a data input to a subsequent time step. Thus, the rules are applied over a time in small increments of time allowing for an analysis of what happens and when a problem is notable.

In yet another exemplary embodiment, a structure and rules applied thereto relate to the remuneration structure of an organization and its interaction with other HR policies, processes, and real-world events. The remuneration structure for a role often includes more than salary—for example performance bonus, stock options, benefits, travel, vacation, pension, etc. The salary component is sometimes composed of base salary, merit component, educational component, experience component, seniority, etc. A remuneration tree structure is formable once the remuneration structure is understood. Also in HR, another structure defines a salary classification scheme providing a series of broad, overlapping salary levels covering all jobs in the company. Individual salary levels within the classification scheme are defined according to criteria such as education, experience, ability, responsibility, etc. An individual within the organization performing a given role thus achieves a certain position within the salary classification structure which links in with the individual's total remuneration package. If that individual subsequently achieves a significant educational milestone pertinent to the job classification (e.g. a masters degree), then the entry of the degree into HR system triggers an educational salary increase per the remuneration structure, and potentially triggers a bump in salary level per that classification structure, and eligibility for other roles that stipulate such a post-graduate degree. Each of these structures is readily visualized. Sometimes, such an advancement is not suited to a particular position and reassignment is advantageous. In addition, the behavioural relationships and interconnections between and among the structures, when viewed, are more easily understood and managed. Visualization of the dynamic inter-workings of the structures in response to information flow due to change present an ROI rich environment.

Numerous other embodiments may be envisioned without departing from the spirit and scope of the invention.

What is claimed is:

1. A method of analyzing information flow within an organization, comprising:
defining interconnections between data nodes belonging to an organizational chart of the organization and network nodes belonging to a computer and information technology network chart of the organization, the defined interconnections for correlating the organizational chart and the computer and information technology network chart in three-dimensions so as to provide a three-dimensional data visualization structure of the organization; establishing rules relating to information flow via the interconnections, the rules based upon a flow structure through the organization;
processing data flow through the organization to move in time from a first data point to a second data point in accordance with the established rules; and,
providing an indication of the result of the processing step.

2. A method according to claim 1 wherein a rule of the established rules relates to one of a data node and a network node of the organization.

3. A method according to claim 1 wherein a rule of the established rules relates to an interconnection within the three-dimensional data visualization structure of the organization.

4. A method according to claim 1 wherein a data node is representative of one of an individual and a department within the organization

5. A method according to claim 1 wherein a data node is representative of a hierarchical structure, the hierarchical structure comprising a sub-organization comprising sub-data nodes.

6. A method according to claim 1 wherein processing data flow through the organization to move in time is performed in time steps, wherein during a single time step rules are applied to data at a start of said time step and wherein during a subsequent time step rules are applied to data at an end of said time step.

7. A method according to claim 6 wherein in aggregate rules are applied to more than one data node in combination during a same time step.

8. A method according to claim 7 for use in processing of audited information of a data flow through an organization.

9. A method according to claim 7 for use in simulating a data flow through an organization.

10. A method of analyzing information flow within an organization, comprising:
defining a three-dimensional data visualization structure of the organization including interconnections between organizational elements of the organization;
processing data flow based on a set of known rules relating to information flow via the interconnections and based upon a flow structure through the organization, so as to simulate moving in time through organizational data upon the set of known rules, from a first endpoint data in order to generate a second endpoint data, the second endpoint data one of forward and backward in time relative to the first endpoint data;
verifying the second endpoint data against a predetermined outcome; and,
providing an indication of the result of verifying.

11. A method according to claim 10 wherein a rule of the set of known rules relates to an organizational element of the organization.

12. A method according to claim 10 wherein a rule of the set of known rules relates to an interconnection within the three-dimensional data visualization structure of the organization.

13. A method according to claim 10 wherein an organizational element comprises one of an individual and a department within the organization.

14. A method according to claim 10 wherein an organizational element comprises a hierarchical structure, the hierarchical structure comprising a sub-organization comprising sub-organizational elements.

15. A method according to claim 10 wherein processing data flow through the organization to move in time is performed in time steps, wherein during a single time step rules are applied to data at a start of said time step and wherein during a subsequent time step rules are applied to data at an end of said time step (ditto).

16. A method according to claim 15 wherein in aggregate rules are applied to more than one organizational element in combination during a same time step.

17. A method according to claim 16 for use in processing of audited information of a data flow through an organization.

18. A method according to claim 16 for use in simulating a data flow through an organization.

19. A method of analyzing information flow within an organization, comprising:
defining interconnections between data nodes belonging to a first organizational chart of the organization and data nodes belonging to a second organizational chart of the organization, the defined interconnections for correlating the first organizational chart and the second organizational chart in three-dimensions so as to provide a three-dimensional data visualization structure of the organization;
correlating a three-dimensional visualization of a computer and information technology network of the organization with the three-dimensional data visualization structure of the organization, comprising defining other interconnections relating to node access to the computer and information technology network of the organization;
establishing rules relating to the interconnections and to the other interconnections, the rules based upon a deterministic reporting process;
verifying a set of reporting process values against the three-dimensional data visualization structure of the organization following the rules established for the interconnections and for the other interconnections; and,
providing an indication of the result of verifying.

20. A computer-readable storage medium having stored thereon computer-executable instructions for performing a method of analyzing information flow within an organization, the method comprising:
defining a three-dimensional data visualization structure of the organization including interconnections between organizational elements of the organization;
processing data flow based on a set of known rules relating to information flow via the interconnections and based upon a flow structure through the organization, so as to simulate moving in time through organizational data upon the set of known rules, from a first endpoint data in order to generate a second endpoint data, the second endpoint data one of forward and backward in time relative to the first endpoint data;
verifying the second endpoint data against a predetermined outcome; and,
providing an indication of the result of verifying.
